(19) United States
(12) Patent Application Publication
(10) Pub. No.: US 2015/0068015 A1
(43) Pub. Date: Mar. 12, 2015

(54) EMBEDDED NUT AND METHOD OF ASSEMBLING THE EMBEDDED NUT TO AN AMORPHOUS ALLOY SHEET

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: HUA-SHENG WANG, Shenzhen (CN); ZAI-XIONG HU, Shenzhen (CN); ZE-ZHI ZHU, Shenzhen (CN); YI-MIN JIANG, Shenzhen (CN)

(21) Appl. No.: 14/476,985

(22) Filed: Sep. 4, 2014

(30) Foreign Application Priority Data
Sep. 6, 2013 (CN) 2013104018705

(51) Int. Cl. F16B 37/04; B21D 39/03

(52) U.S. Cl. CPC F16B 37/04; B21D 39/032
USPC 29/428; 411/427

(57) ABSTRACT

Embedded nut for assembling in a Zr-based amorphous alloy material is made of titanium alloy. The embedded nut is hollow and post-shaped, and includes a bottom portion, a middle portion, and a top portion. The top portion includes a shoulder connecting with the middle portion, and a plurality of teeth arranged at the edge of the shoulder. The bottom portion includes a chamfered edge. The high-tensile embedded nut does not shift position when being pressed and assembled into the amorphous alloy material.

### FIELD

The present disclosure relates to embedded nuts, and more particularly, to an embedded nut assembled in an amorphous alloy sheet, and a method of assembling the embedded nut to an amorphous alloy sheet.

### BACKGROUND

Amorphous alloys have certain physical, chemical, and mechanical properties, such as high strength, high hardness, high wear resistance, high corrosion resistance, high plasticity, high resistance, good superconductivity, and low magnetic loss; thus, they have been applied in a wide range of fields, such as mechanics, medical equipment, electrical applications, and for military purposes.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a perspective view of a Zr-based amorphous alloy sheet.

FIG. 2 is a cross-sectional view of the Zr-based amorphous alloy sheet taken along a line II-II as shown in FIG. 1.

FIG. 3 is a perspective view of an embedded nut.

FIG. 4 is a top view of the embedded nut as shown in FIG. 3.

FIG. 5 is a perspective view of the Zr-based amorphous alloy sheet assembled with embedded nuts.

FIG. 6 is a cross-sectional view of Zr-based amorphous alloy sheet assembled with embedded nuts as shown in FIG. 5.

### DETAILED DESCRIPTION

This disclosure is illustrated by way of example and not by way of limitation in the figures of the accompanying drawings in which like reference numbers indicate similar elements. It should be noted that references to “an” or “one” embodiment in this disclosure are not necessarily to the same embodiment, and such references mean “at least one”.

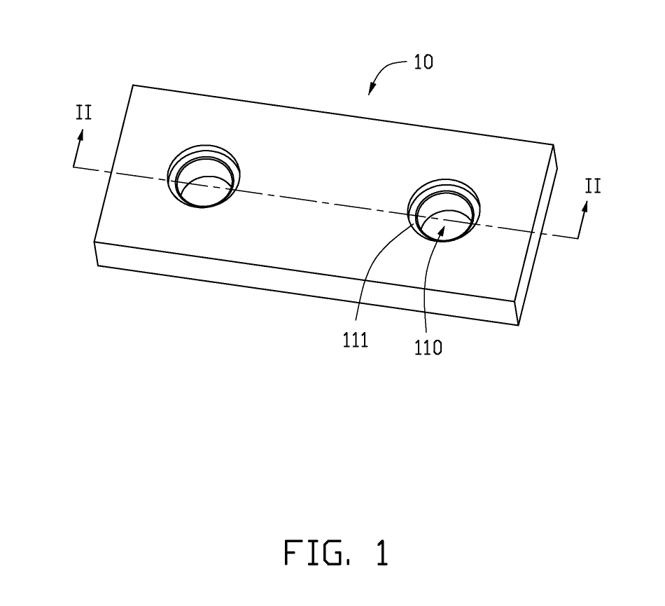

FIG. 1 illustrates a zirconium-based (hereinafter referred to as Zr-based) amorphous alloy sheet 10. The Zr-based amorphous alloy sheet 10 can include at least one assembly hole 110. In the illustrated embodiment, there are two assembly holes 110.

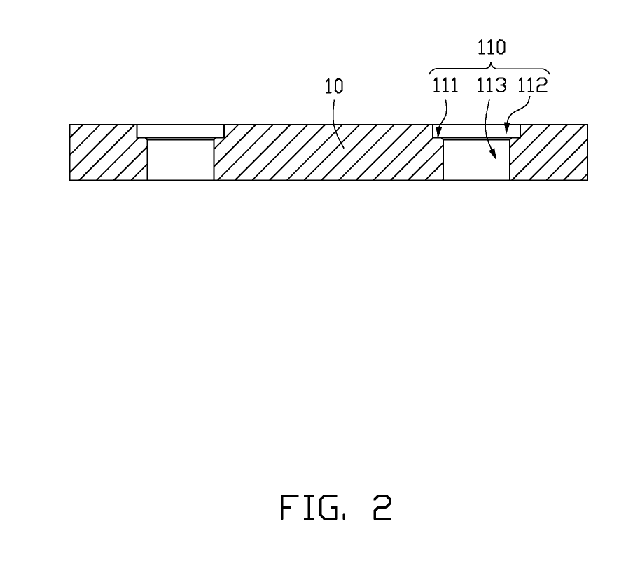

FIG. 2 illustrates that the assembly hole 110 can be a circular hole through the Zr-based amorphous alloy sheet 10. The assembly hole 110 includes a stepped surface 111, which divides the assembly hole 110 into a top assembly hole 112 upon the stepped surface 111 and a bottom assembly hole 113 below the stepped surface 111. A diameter of the bottom assembly hole 113 is smaller than a diameter of the top assembly hole 112, thus the assembly hole 110 is a stepped hole. In another embodiment, the number and the structure of the assembly hole 110 can be designed according to requirements.

The Zr-based amorphous alloy sheet 10 is made by pressure embedding process, and can include about 50 to 70 percent by weight zirconium (Zr), 10 to 15 percent by weight copper (Cu), 5 to 10 percent by weight nickel (Ni), 5 to 20 percent by weight niobium (Nb), and 5 to 10 percent by weight aluminum (Al). The Zr-based amorphous alloy sheet 10 can have other elements.

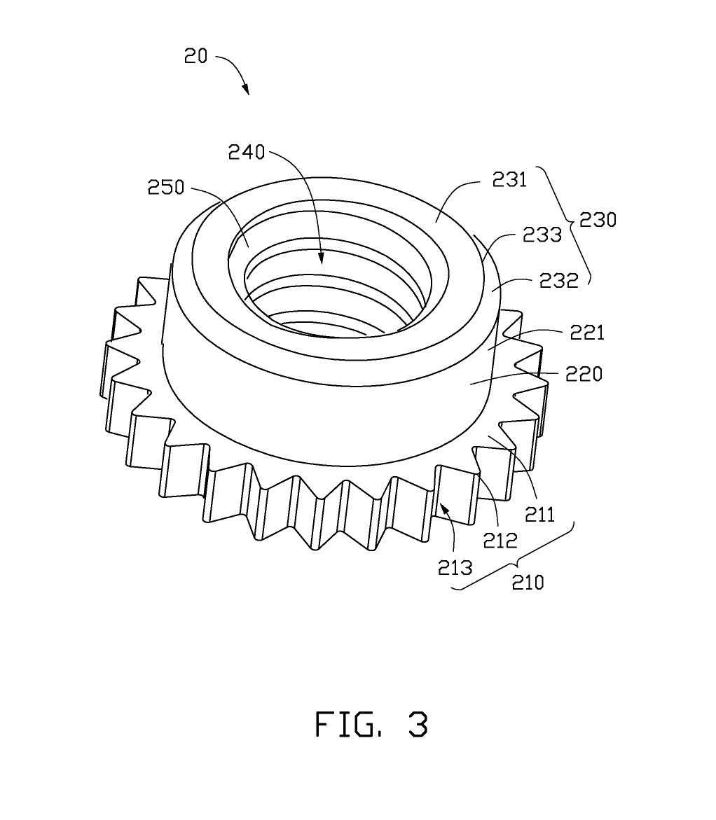

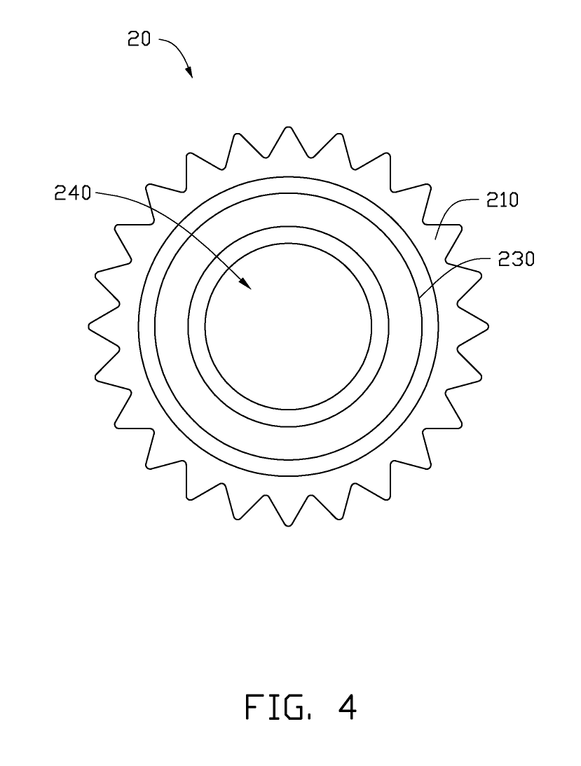

FIG. 3 and FIG. 4 illustrate the embedded nut 20. The embedded nut 20 can be hollow and post-shaped and includes a top portion 210, a middle portion 220, and a bottom portion 230. The top portion 210 and the bottom portion 230 are positioned at two ends of the middle portion 220. The embedded nut 20 can further include a round screw hole 240 in the center thereof.

The middle portion 220 of the embedded nut 20 can be hollow and post-shaped, and an outer surface of the middle portion 220 is a cylindrical surface 221 which is smooth. The cylindrical surface 221 is matched with the assembly hole 110, and a diameter of the cylindrical surface 221 can be substantially equal to the diameter of the bottom assembly hole 113.

The top portion 210 includes a shoulder 211 connected with the middle portion 220. The shoulder 211 and the middle portion 220 can form a stepped structure. The edge of the shoulder 211 defines a toothed portion comprising a plurality of teeth 212. The plurality of teeth 212 have a thickness substantially equal to the shoulder 211. As the embedded nut 20 includes a plurality of teeth 212, the embedded nut 20 which has a lower hardness is easy to be embedded into the Zr-based amorphous alloy sheet 10 which has a higher hardness, and the connection strength of the embedded nut 20 and the Zr-based amorphous alloy sheet 10 is improved. The top portion 210 further includes a plurality of concave spaces 213 between two neighboring teeth 212. When pressing the embedded nut 20 into the Zr-based amorphous alloy sheet 10, the edge of the teeth 212 can be cut, thus metal scraps from the teeth 212 can be generated. The metal scraps can be received in and removed from the concave spaces 213. A diameter of the top portion 210 is slightly larger than the diameter of the top assembly hole 110, so that the embedded nuts 20 can be assembled in the Zr-based amorphous alloy sheet 10 by an interference fit.

The bottom portion 230 includes a first side surface 231 and a second side surface 232 connected with the first side surface 231. The first side surface 231 and the second side surface 232 are annular, and connected with the middle portion 220. The first side surface 231 defines a circular hole in the center. The bottom portion 230 further includes a chamfered portion 233 which is annular between the first side surface 231 and the second side surface 232. The chamfered portion 233 prevents any shifting of the embedded nut 20 when being initially pressed into the Zr-based amorphous alloy sheet 10.

The embedded nut 20 further includes a threaded portion 250 arranged on the inner surface of the top portion 210, the middle portion 220, and the bottom portion 230.

In at least one embodiment, the embedded nut 20 is made of titanium alloy to have high hardness. The embedded nut 20 can include Al, manganese (Mn), iron (Fe), carbon (C), nitrogen (N), hydrogen (H), oxygen (02), titanium (Ti), and other impurities. The embedded nut 20 can also be made of an alloy including Al, vanadium (V), Fe, C, N, H, O2, Ti, and impurities. For example, the embedded nut 20 includes 1.0 to 2.5 percent by weight of Al, 0.7 to 2.0 percent by weight of Mn, equal to or less than 0.30 percent by weight of Fe, equal to or less than 0.08 percent by weight of C, equal to or less than 0.05 percent by weight of N, equal to or less than 0.012 percent by weight of H, equal to or less than 0.15 percent by weight of 02, equal to or less than 0.4 percent by weight of impurities, and the remainder of Ti.

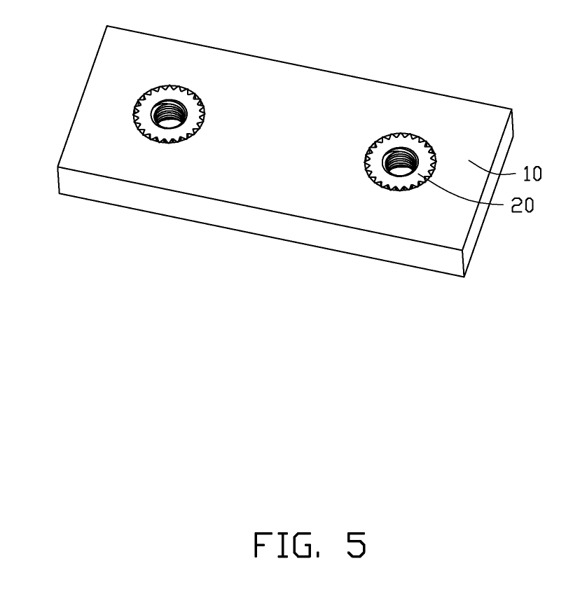

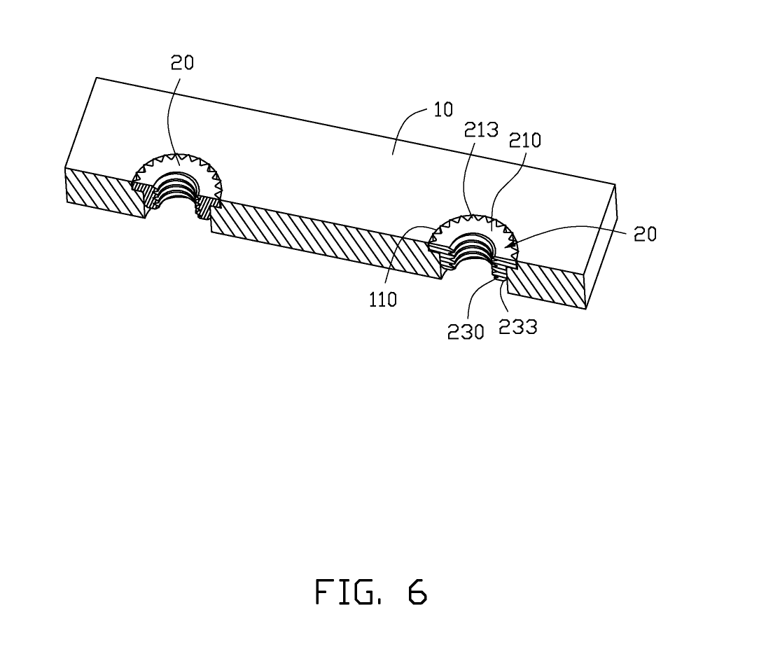

FIG. 5 and FIG. 6 illustrate the embedded nut 20 assembled in the Zr-based amorphous alloy sheet 10. At least one assembly hole 110 is initially defined in the Zr-based amorphous alloy sheet 10. When pressing the embedded nut 20 into place, the bottom portion 230 is aligned with the assembly hole 110, and the embedded nut 20 is assembled in the Zr-based amorphous alloy sheet 10 by an interference fit.

The precision of the assembly can be increased and the embedded nut 20 does not shift in the assembly hole 110 because the bottom portion 230 of the embedded nut includes the chamfering 233. After the embedded nut 20 is assembled into the Zr-based amorphous alloy sheet 10, the shoulder 211 is squeezed into the assembly hole 110 until substantially coplanar with the surface of the Zr-based amorphous alloy sheet 10. The teeth 212 are inserted into the Zr-based amorphous alloy sheet 10, thus the connection strength is increased. Only a few portions of the teeth may be cut, and the metal scraps can be received in the spaces 213 between the teeth and removed those spaces. After the embedded nut is assembled, the Zr-based amorphous alloy sheet 10 presents a neat and clean appearance, and the fitment-size of the alloy sheet 10 will not be affected.

The embedded nut 20 has the advantages of high assembly accuracy and high tensile strength. In testing, the compressive strength shows about 200 to 400 Mpa, and the torsional capabilities are about 3.0˜6.0 kgfcm. The embedded nut 20 satisfies the requirements of a welded assembly in the electronics industry.

It is believed that the present embodiments and their advantages will be understood from the foregoing description, and it will be apparent that various changes can be made thereto without departing from the scope of the embodiments or sacrificing all of its material advantages. The embodiments described herein are illustrative only and should not be construed to limit the following claims.

What is claimed is:

1. An embedded nut, comprising:
a bottom portion;
a middle portion;
a top portion;
the top portion and the bottom portion are arranged at two ends of the middle portion;
the top portion comprises a shoulder connecting with the middle portion, and a plurality of teeth arranged at the edge of the shoulder; and
the bottom portion comprises a chamfering.

2. The embedded nut as claimed in claim 1, wherein the embedded nut is made of titanium alloy and hollow post-shaped.

3. The embedded nut as claimed in claim 1, wherein the plurality of teeth are continuous tooth-shaped, and the top portion further comprises a plurality of concave spaces between each two neighboring teeth.

4. The embedded nut as claimed in claim 1, wherein the bottom portion further comprises a first side surface and a second side surface connected with the first side surface, and the chamfering is arranged between the first side surface and the second side surface.

5. The embedded nut as claimed in claim 3, wherein the first side surface and the second side surface are connected with the middle portion, and the first side surface and the second side surface are ring surfaces.

6. The embedded nut as claimed in claim 1, wherein the middle portion is hollow post-shaped.

7. The embedded nut as claimed in claim 1, wherein the embedded nut comprises Al, Mn, Fe, C, H, N, O, and Ti.

8. The embedded nut as claimed in claim 1, wherein the embedded nut comprises Al, V, Fe, C, H, N, O, and Ti.

9. A method of assembling an embedded nut to a Zr-based amorphous alloy sheet, comprising:
providing a Zr-based amorphous alloy sheet, wherein the Zr-based amorphous alloy sheet comprises at least one stepped assembly hole;
providing an embedded nut, wherein the embedded nut comprises a bottom portion, a middle portion, and a top portion; the top portion and the bottom portion are arranged at two ends of the middle portion; the top portion comprises a shoulder connecting with the middle portion, and a plurality of teeth arranged at the edge of the shoulder; and the bottom portion comprises a chamfering;
pressing the embedded nut to the assembly hole of the Zr-based amorphous alloy sheet by an interference fit.

10. The method as claimed in claim 9, wherein the shoulder is squeezed into the assembly hole until substantially coplanar with the surface of the Zr-based amorphous alloy sheet.

11. The method as claimed in claim 9, wherein the teeth are inserted into the Zr-based amorphous alloy sheet.

12. The method as claimed in claim 9, wherein the embedded nut is made of titanium alloy and hollow post-shaped.

13. The method as claimed in claim 9, wherein the plurality of teeth are continuous tooth-shaped, and the top portion further comprises a plurality of concave spaces between each two neighboring teeth.

14. The method as claimed in claim 9, wherein the bottom portion further comprises a first side surface and a second side surface connected with the first side surface, and the chamfering is arranged between the first side surface and the second side surface.

15. The method as claimed in claim 14, wherein the first side surface and the second side surface are connected with the middle portion, and the first side surface and the second side surface are ring surfaces.
